(19) United States
(12) Patent Application Publication
(10) Pub. No.: US 2010/0132014 A1
(43) Pub. Date: May 27, 2010

(54) SECURE COMPOSITION OF WEB SERVICES

(75) Inventors: Frederic Montagut, Zurich (CH); Alessandro Sorniotti, Antibes (FR); Claudia Villalonga, Zurich (CH)

Correspondence Address: BRAKE HUGHES BELLERMANN LLP, C/O CPA Global, P.O. BOX 52050, MINNEAPOLIS, MN, 55402, US

(73) Assignee: SAP AG, Walldorf (DE)

(21) Appl. No.: 12/637,298

(22) Filed: Dec. 14, 2009

(30) Foreign Application Priority Data
Sep. 10, 2008 (EP) 08290859.1

(51) Int. Cl. G06F 21/00; G06F 15/16

(52) U.S. Cl. 726/1; 709/225

(57) ABSTRACT

A method includes providing a model which allows to define acceptable sets of security features ((sfₖ(W))_{k ∈ [1,1]}) associated with a workflow model (W) representing a composite web service (C), and to enable to advertise security features (SMS(sᵢ)) which are supported by candidate web services (sᵢ), and defining, based on the model, an assignment procedure which allows to build, a secure compliant composite web service, where the assignment procedure is an iterative process in that web services are assigned to workflow tasks one after the other such that after each iteration a subset of the at least one acceptable set of security features which is supported by the web services already assigned is analyzed in view of the next succeeding workflow task of the workflow model so as to be successively completed to the at least one acceptable set of security features by compliant candidate web services.

### CROSS-REFERENCE TO RELATED APPLICATION

This application claims priority under 35 U.S.C. §119 to European Patent Application EP08290859.1, filed Sep. 10, 2008, titled “SECURE COMPOSITION OF WEB SERVICES,” which is incorporated herein by reference in its entirety.

### TECHNICAL FIELD

The present disclosure refers to a method and a system for automating an integration of security features as part of a composition procedure of web services.

### BACKGROUND

Current approaches in web services composition do not take into account security requirements defined by workflow designers. It, however, may become critical to consider the security requirements of non-functional attributes within an automatic composition of web services. Composite application designers may indeed specify some security requirements in addition to functional ones which should be satisfied by candidate web services in order to be assigned to respective tasks of a workflow which represents a composite web service which is to be designed.

### SUMMARY

Hereinafter, “composite application”, and “composite web service” are used synonymously. The terms “web service” and “service” are also used synonymously. The terms “workflow” and “workflow model” are also interchangeable one with another. The same applies to the expressions “advertised security features and “advertised security mechanisms”.

Previous systems and techniques may not take into account security requirements defined by workflow designers in a composition of web services. Therefore, there is a need for a process to automate a secure composition of web services.

A variety of services may be available to be used for a generation of a composite web service. It may be desired to compose web services of a variety of web services so that the composition of the web services is performed not only according to functional attributes but also to security ones. It may be desired to consider security features non-functional attributes during an automatic composition of web services.

Therefore, an aspect of the present disclosure, includes a method for automating an integration of security features as part of a composition procedure of web services. The method includes providing a model which allows to define acceptable sets of security features associated with a particular workflow representing a composite web service and to enable to advertise security features which are supported by available candidate web services. The method may further include defining, generating and performing, based on the model, an assignment procedure which allows to build, based on the available candidate web services, a secure compliant composite web service which satisfies at least one of the acceptable sets of security features of the workflow, where the assignment procedure is an iterative process in that web services are assigned to workflow tasks one after the other such that after each iteration a subset of the at least one acceptable set of security features which is supported by the web services already assigned is analyzed in view of the next succeeding workflow task of the workflow model so as to be successively completed to the at least one acceptable set of security features by compliant candidate web services.

Thereby, it is possible that the acceptable sets of security features which are associated with the particular workflow model representing a composite web service are matched against the advertised security features which are supported by available candidate web services.

Furthermore, according to a further implementation, it is possible that, given the particular workflow W consisting of n tasks (tᵢ)_{i ∈[1,n]}, he assignment procedure outputs a compliant composite web service Wₛ=(sᵢ)_{i ∈[1,n]} composed of a set of n component services sᵢ that have been assigned to the tasks (tᵢ)_{i ∈[1,n]} of the particular workflow W.

The acceptable sets of security features designated as (sfⱼ(W))_{j ∈ [1,1]} and associated with a particular workflow model W which represents a composite web service C, and the advertised security features designated as SMS(sᵢ) which are supported by available candidate web services (sᵢ) can be described using WSDL (Web Service Definition Language).

According to another possible implementation, for the particular workflow W an operator security features is provided that associates with each task of the workflow W a set of security mechanisms (sf^{k}(W))_{k ∈ [1,n]}.

Thereby, it is possible that the sets of security mechanisms, each being associated with a respective task, and the acceptable sets of security features (sfⱼ(W))_{j ∈ [1,1]} associated with the workflow W are represented in form of a matrix or table, thus indicating existing overlapping between the sets of security mechanisms, each being associated with a respective task, and the acceptable sets of security features (sfⱼ(W))_{j ∈ [1,1]} associated with the workflow W.

The secure compliant composite web service Wₛ(sᵢ)_{i ∈ [1,1]} can be described in that it satisfies the following proposition:

∃η ∈ [1, 1] such that ∀i ∈ [1, n] sf_{η}ⁱ(W) ⊂ SMS(sᵢ)

wherein SMS(sᵢ) corresponds to a set of security mechanisms of a respective component web service sᵢ.

It is possible that after each iteration i a partial workflow instance Wₛⁱ is created and a group of sets of security features ASF_{C}(Wₛⁱ)=sfₕ(Wₛⁱ)_{h ∈ [1,m]} associated with the partial workflow instance Wₛⁱ and whose elements are satisfied by the partial workflow instance Wₛⁱ are determined. Thereby, the group of sets of security features associated with the partial workflow instance Wₛⁱ is a subset of the group of sets of security features ASF_{C}(W)=(sfⱼ(W))_{j ∈ [1,1]} associated with the particular workflow W. Based on the group of sets of security features ASF_{C}(Wₛⁱ)=(sfₕ(Wₛⁱ))_{h ∈ [1,m]} associated with the partial workflow instance Wₛⁱ, security requirements that are to be satisfied by candidate component services in order to be assigned to subsequent workflow tasks of the particular workflow are computed.

According to another implementation the candidate component services are computed by using the following conditions:

∀i ∈ [1, n] ASF_{C}(Wₛⁱ) ⊂ ASF_{C}(Wₛⁱ⁻¹) ⊂ ASF_{C}(W)

wherein ASF_{C}(Wₛ⁰)=ASF_{C}(W) and ASF_{C}(Wₛⁱ) is the group of sets of security features associated with the partial workflow instance Wₛⁱ and ASF_{C}(W) is the group of acceptable sets of security features associated with the particular workflow W.

Thereby it is possible that a service sₐ is classified as an adequate candidate component service to be assigned to task tₐ of the assignment procedure if:

∃T ∈ Minₛₘ(sₐ, tₐ, Wₛⁱ)={sf_{y}^{a}(W)|sf_{y}(W) ∈ ASF_{C}(Wₛⁱ⁻¹)}

such that T ⊂ SMS (sₐ) wherein SMS (sₐ) are the advertised security features of service sₐ.

A further aspect of the present disclosure includes a system for automating an integration of security features as part of a composition procedure of web services. The system has a modeling unit and an assignment unit. The modeling unit is configured to provide a model which allows to define acceptable sets of security features associated with a particular workflow model representing a composite web service, and to enable to advertise security features which are supported by available candidate web services. The assignment unit is configured to define, generate and perform, based on the model, an assignment procedure which allows to build, based on the available candidate web services, a secure compliant composite web service which satisfies at least one of the acceptable sets of security features of the workflow model, where the assignment procedure is an iterative process in that web services are assigned to workflow tasks one after the other such that after each iteration a subset of the at least one acceptable set of security features which is supported by the web services already assigned is analyzed in view of the next succeeding workflow task of the workflow model so as to be successively completed to the at least one acceptable set of security features by compliant candidate web services.

According to a possible implementation, the assignment unit is configured to match acceptable sets of security features associated with the particular workflow model representing the composite web service against the advertised security features which are supported by available candidate web services.

Given the particular workflow W consisting of n tasks (tᵢ)_{i ∈[1,n}], the assignment unit may be configured to output a compliant composite web service Wₛ=(sᵢ)_{i ∈[1,n]} composed of a set of n component services sᵢ that have been assigned to the tasks (tᵢ)_{i ∈[1,n]} of the particular workflow W.

The modeling unit may be configured to provide, for the particular workflow W an operator security features that associates with each task of the workflow W a set of security mechanisms ((sf^{k}(W))_{k ∈ [1,n]}).

Furthermore, the modeling unit may be configured to represent the set of security mechanisms, each being associated with a respective task and the acceptable sets of security features associated with the workflow W in form of a matrix or table, thus indicating existing overlapping between the sets of security mechanisms, each being associated with a respective task, and the acceptable sets of security features ((sfⱼ(W))_{j ∈ [1,1]}) associated with the workflow W.

The assignment unit may be configured to create after each iteration i a partial workflow instance Wₛⁱ and to determine a group of sets of security features ASF_{C}(Wₛⁱ)=(sfₕ(Wₛⁱ))_{h ∈ [1,m]} associated with the partial workflow instance Wₛⁱ and whose elements are satisfied by the partial workflow instance Wₛⁱ, the group of sets of security features associated with the partial workflow instance Wₛⁱ being a subset of the set of security features ASF_{C}(W)=(sfⱼ(W))_{j ∈ [1,1]} associated with the particular workflow (W), and to compute, based on the group of sets of security features ASF_{C}(Wₛⁱ)=(sfₕ(Wₛⁱ))_{h ∈ [1,m]} associated with the partial workflow instance Wₛⁱ, security requirements that are to be satisfied by candidate component services in order to be assigned to subsequent workflow tasks of the particular workflow.

The assignment unit may be configured to compute the candidate component services by using the following conditions:

∀i ∈ [1, n] ASF_{C}(Wₛⁱ) ⊂ ASF_{C}(Wₛⁱ⁻¹) ⊂ ASF_{C}(W)

wherein ASF_{C}(Wₛ⁰)=ASF_{C}(W) and ASF_{C}(Wₛⁱ) is the group of sets of security features associated with the partial workflow instance Wₛⁱ and ASF_{C}(W) is the group of sets of security features associated with the particular workflow W.

The assignment unit may classify a service sₐ as an adequate candidate component service to be assigned to task tₐ of the assignment procedure if:

∃T ∈ Minₛₘ(sₐ, tₐ, Wₛⁱ)={sf_{y}^{a}(W)|sf_{y}(W) ∈ ASF_{C}(Wₛⁱ⁻¹)}

such that T ⊂ SMS (sₐ) wherein SMS (sₐ) are the advertised security features of service sₐ.

A further aspect includes a computer program product with instructions for a computer system. The instructions are configured to cause the computer system to perform the disclosed method, or to realize the proposed system, respectively.

One exemplary implementation of the proposed method and system is to consider security features non-functional attributes during an automatic composition of web services. In order to achieve the latter, an appropriate model is firstly defined so that on the one hand workflow designers can define security requirements associated with a particular workflow model and on the other hand to enable service providers to advertise security features offered by available candidate web services. Based on the latter, an assignment procedure is defined and generated that takes as input the defined security requirements as part of a composition procedure for a composite web service. The model allows to specify some security requirements that should be satisfied by a composite application. Those security requirements are then integrated automatically in a subsequent assignment procedure. The model makes it possible to match what is required as security features against what can be offered by available candidate web services in the same fashion as an usual match-making procedure for functional attributes.

The following description of examples includes details for illustrating embodiments and is not intended to limit the scope of the embodiments or to be exhaustive. For purposes of explanation, specific details are set forward in order to provide a thorough understanding of examples and embodiments. A person skilled in the art may appreciate that further embodiments may be practiced with details that differ from specific details.

Further features and embodiments will become apparent from the description and the accompanied drawings.

It will be understood that the features mentioned above and those described hereinafter can be used not only in the combination specified but also in other combinations or on their own, without departing from the scope of the present disclosure.

Various implementations are schematically illustrated in the drawings and are hereinafter explained in detail with reference to the drawings. It is understood that both the foregoing general description and the following description of various embodiments are exemplarily and explanatory only and are not meant to be restrictive or to be read into the claims. The accompanying drawings which are incorporated in a constitutive part of this specification, illustrate some embodiments, and together with the description serve to explain the principles of the embodiments described herein.

### BRIEF DESCRIPTION OF THE DRAWINGS

FIG. 1 shows a schematic view of an embodiment of a system according to the present disclosure.

FIG. 2 shows a further embodiment of a system according to the present disclosure.

FIG. 3 shows a table as used as an input for the proposed assignment procedure, the table comprising defined security requirements as part of a composition procedure of a composite web service represented by a workflow model.

FIG. 4 shows an example of a workflow model as used by an embodiment of the proposed method.

FIG. 5 shows a table of web services available as candidate web services for a composition of a composite web service, the table indicating security features offered by the respective candidate web services and being used as an input for the proposed assignment procedure.

### DETAILED DESCRIPTION

Given a workflow W consisting of n tasks (tᵢ)_{i ∈ [1,n]} the proposed method outputs a workflow instance or composite web service Wₛ composed of a set of n component web services that have been assigned to the tasks of the workflow W. The composite web service or the workflow instance can be described by Wₛ=(sᵢ)_{i ∈ [1,n]}.

Reference will now be made in detail to some embodiments, examples of which are illustrated in the accompanying drawings. Wherever possible, the same reference numbers are used throughout the drawings to refer to the same of like parts.

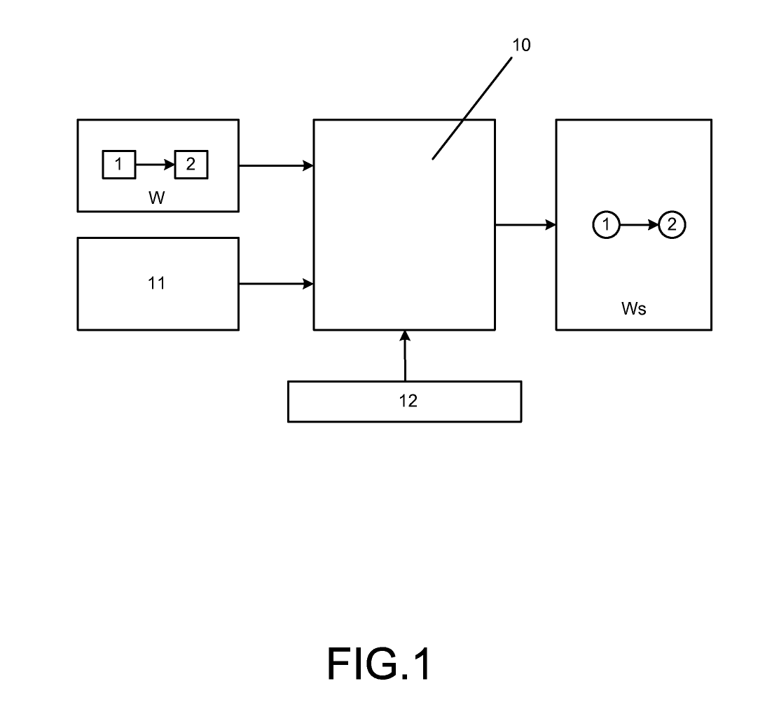

FIG. 1 shows a very schematic view of a system as proposed by the present disclosure. The system is designated with reference number 10. A workflow W, which is designed by a workflow designer, is pregiven as an input to the proposed system 10. In the case, shown here, workflow W consists of two tasks 1, and 2. Furthermore, the workflow designer can specify some security requirements 11 for the workflow W, which is also given as an input to the system 10. Besides the workflow W with its security requirements 11, it is possible to input available candidate web services 12 which can be composed to a composed web service. All available candidate web services 12 can be advertised together with security mechanisms which are satisfied by the respective web services. The proposed system 10 uses those inputs for an automatic generation of a composite web service, whereby the generated composite web service satisfies not only the functional attributes, namely by fulfilling the respective workflow tasks 1, and 2, but also the required security features 11 which were given as a further input by a respective workflow designer. The system 10 uses for the secure composition of the composite web service the candidate web services which are available and which are also given as an input to the system 10. Given the workflow W consisting of several tasks the system 10 outputs a workflow instance Wₛ which fulfills the respective workflow tasks 1, and 2 and also meets the defined security requirements 11.

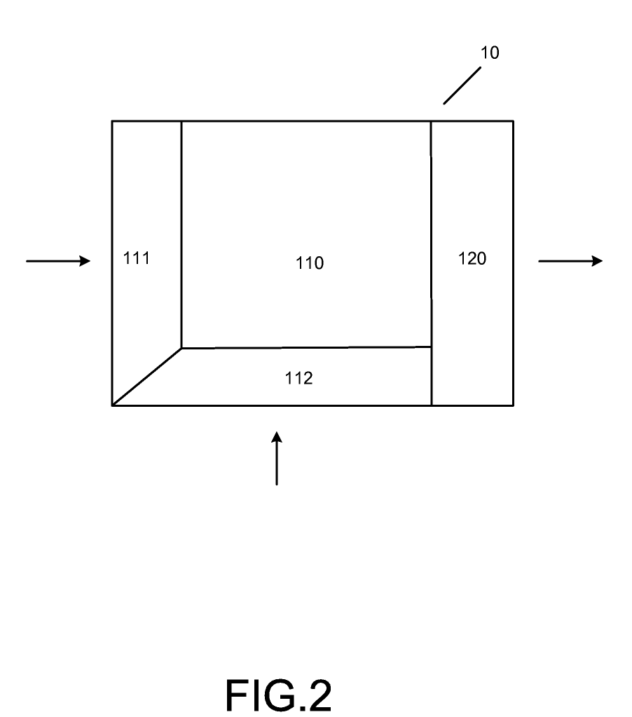

FIG. 2 shows a second embodiment of a system according to the present disclosure. In the second embodiment, the system 10 is shown in further detail. The system 10 comprises a modeling unit 110 and an assignment unit 120. The system 10 further comprises an interface 111 via which a workflow W comprising a plurality of workflow tasks and security requirements defined for a respective workflow W can be provided as input to the modeling unit 110. The system 10 further comprises a second interface 112 which can be used to input available web services as potential candidate web services for a composition of a composite web service according to the inputted workflow model W. The web services can be provided together with respective sets of security mechanisms which are satisfied by the respective web services. The modeling unit 110 is configured to provide a model which allows to define, via the respective interface 111, acceptable sets of security features associated with an inputted particular workflow model representing a composite web service and to enable, via the second interface 112, to advertise security features which are supported by available candidate web services. The modeling unit 110 interfaces with the assignment unit 120. Via the interface 112, a service provider may advertise available web services and security mechanisms the web services support, e.g. an encryption or signature schemes, in a WSDL specification. The modeling unit 110 allows to receive acceptable sets of security features associated with the particular workflow model representing the composite web service which is to be composed and security features which are supported by available candidate web services which are to be used to compose the respective composite web service.

The modeling unit 110 cooperates with the assignment unit 120 in that the assignment unit 120 allows to define, generate and perform, based on the model which is provided by the modeling unit 110, an assignment procedure which allows to build, based on the available candidate web services, a secure compliant composite web service which satisfies at least one of the acceptable pregiven sets of security features of the workflow model.

The assignment procedure performed by the assignment unit 120 is an iterative process in that web services of a plurality of available web services are assigned to workflow tasks of the respective workflow model one after the other such that after each iteration a subset of the at least one acceptable set of security features which is supported by the web services already assigned is analyzed in view of the next succeeding workflow task of the workflow model so as to be successively completed to the at least one acceptable set of security features by compliant candidate web services. The composite web service is then outputted by the assignment unit 120 as a result of the secure composition of web services. It is to be noted that a definition of an ontology used by partners, i.e. service providers and workflow designers to specify security mechanisms is out of the scope of the present disclosure. It is assumed that all involved parties share a common ontology to advertise respective security mechanisms which are supported by the respective web services and which are required for a secure composition of web services.

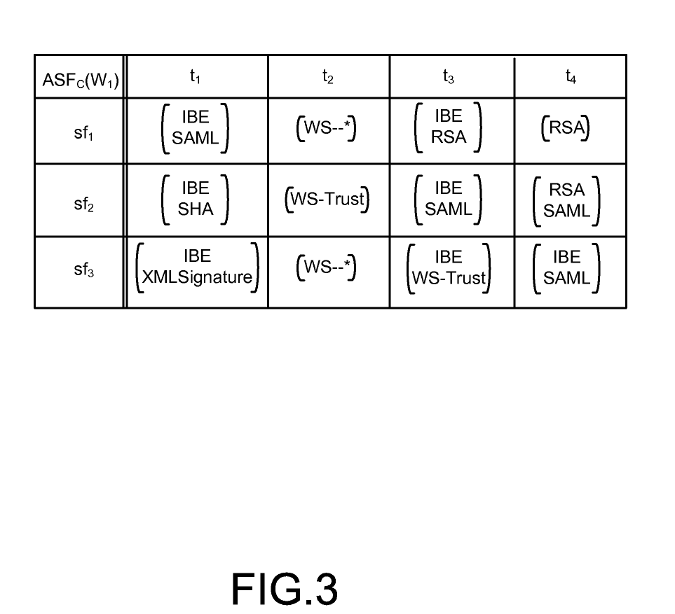

FIG. 3 shows an exemplary presentation of acceptable sets of security features associated with a particular workflow model representing a composite web service. Those acceptable sets of security features can be pregiven by a workflow designer. The table represents acceptable sets of security features for a workflow model W₁. The workflow model W₁ comprises four workflow tasks t₁, t₂, t₃, and t₄. Those tasks are assigned, respectively, to different columns. For the whole workflow model W₁ there are defined three different sets of security features which are acceptable. Those sets of security features are assigned, respectively, to different rows. The different sets of security features are denoted as sfᵢ. A row which is assigned to a particular set of security features sfᵢ indicates for each task tⱼ an acceptable subset of security features sfᵢ^{j} for this individual single task tⱼ. Therefore, the acceptable set of security features sf₁ indicates that for task t₁ the subset of security features sf₁¹={IBE, SAML} is acceptable as a set of security features for this particular workflow task. The same acceptable set of security features sf₁ allows for the further workflow task t₂ the security feature sf₁²={WS−*}. For the workflow task t₃, the acceptable set of security features sf₁ allows the subset of security features sf₁³={IBE, RSA}. Finally, the same acceptable set of security features sfᵢ allows for the last workflow task t₄ the security feature sf₁⁴={RSA}.

For the further acceptable sets of security features sf₂ and sf₃, there are different subsets of security features, respectively, which are allowable for the different single workflow tasks t₁ to t₄ as indicated in the respective rows of the table of FIG. 3.

A basic idea of the proposed dynamic web service composition is to select from a pool of available component web services those that satisfy pregiven security requirements which can be presented, as indicated in FIG. 3, in an appropriate table. As workflow designers do not know in advance what functionalities will be offered by candidate component web services at the composition stage, it is desired to be as flexible as possible so that a composition process can find a suitable set of component web services to execute a pregiven particular workflow.

In order to achieve this required flexibility, a model is provided which allows to define multiple acceptable sets of security features in order to specify security requirements associated with a composite web service which is to be generated. Therefore, acceptable sets of security features sfₖ(W) associated with a particular workflow model representing a composite web service are defined, each of which associates with each task tᵢ of the workflow W a set of security mechanisms SMT^{k}ᵢ so that each acceptable set of security features sfₖ(W) can be given as sfₖ(W)=(SMT^{k}₁, . . . , SMT^{k}ₙ)={sfₖⁱ(W)_{i ∈ [1,n]}} wherein k ∈ [1, 1], i.e. there are 1 alternative acceptable sets of security features which are deemed to be sufficient in order to execute the composite web service. It is to be noted that each task tᵢ is, thus, associated with a set of security mechanisms SMTᵢ=SMTᵢ¹ ∪ SMTᵢ² ∪ . . . ∪ SMTᵢ¹ in case that there exist 1 alternative acceptable sets of security features sfₖ(W).

In the following a group of acceptable sets of security features defined for a particular composite web service C which is represented by a workflow W is denoted as ASF_{C}(W)=(sfₖ(W))_{k ∈ [1,1]}. This group ASF_{C}(W) defines the acceptable sets of security features sfₖ(W) of workflow W, each set being deemed sufficient in order to execute the composite web service C which is to be generated.

FIG. 3 shows a table which represents the group ASF_{C} for the composite service C represented by a workflow W₁. The table basically represents a number of alternative sets of security features sfₖ, each set of security features comprising sets of security mechanisms SMT^{k}ᵢ associated with respective tasks t, of the workflow W₁, wherein the security mechanisms are considered compliant with predefined requirements of the composite web service C.

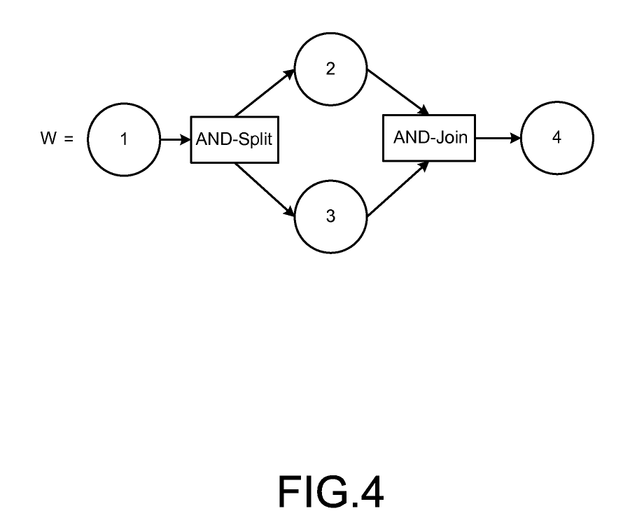

FIG. 4 shows a workflow example W₁, the workflow comprising four tasks t₁, t₂, t₃, and t₄. The workflow tasks are combined, thus representing a specific composite web service. Task t₁ is combined with the subsequent tasks t₂, and t₃, by an “AND-Split”-operator. Tasks t₂ and t₃ are combined with the final task t₄ by an “AND-Join”-operator.

In the following, an exemplary actual assignment procedure that takes as input security requirements defined for a specific composite web service C based on a workflow W and a pool of available component services in order to build a secure composite application Wₛ that meets the predefined security requirements ASF_{C}(W) is specified. In the following, such a composite web service Wₛ is called a compliant composite web service or a compliant composite application and satisfies the following proposition:

∃η ∈[1,1] such that ∀i∈[1,n]sf_{η}ⁱ(W)⊂SMS(sᵢ) (1)

In other words, a composite web service that satisfied at least one of the acceptable sets of security features sfⱼ of the workflow W representing the composite service C is to be generated. In order to achieve this ultimate goal, an assignment procedure is defined as follows. As already outlined before, the proposed assignment procedure is an iterative procedure, in that component web services are assigned to respective workflow tasks one after the other. Thus, after each iteration i a partial workflow instance Wₛⁱ is created. The generation process relies in that security properties offered by Wₛⁱ given the security mechanisms supported by the i web services already assigned matches at least one of the acceptable sets of security features for any step i of the assignment process. For all i in the interval [1,n] the set or group ASF_{C}(Wₛⁱ) that is a subset of ASF_{C}(W) whose elements are satisfied by the respective partial workflow instance Wₛⁱ is defined which gives the security mechanisms supported by the i component web services already assigned.

An aspect behind the proposed assignment procedure is the following. At each step i the security requirements that should be satisfied by a candidate web service in order to be assigned to a respective considered workflow task is computed. The security requirements basically depend on two aspects, namely what is directly required by the respective workflow task and what security mechanisms are offered by the web services assigned so far to the partial workflow instance Wₛⁱ⁻¹. The former, namely the security requirements of the respective workflow task can be easily derived from a respective ASF_{C}(W) table as indicated in FIG. 3 for workflow W₁. These security requirements are direct requirements. The security requirements which are to be derived from the security mechanisms which are offered by the component web services which are already assigned are to be derived from the fact that the assignment of particular component web services impacts an assignment of further component web services. An assignment of a particular component web service to a task of a workflow representing a composite web service which is to be generated at a step i implies that a subset of the acceptable set of security features that is satisfied by the partial instance Wₛ^{i 1} is no longer satisfied by the further partial workflow instance Wₛⁱ. This subset can be empty provided that the further assigned component web service supports the adequate security mechanisms to meet all requirements associated with the considered task. Thus, actually setting ASF_{C}(Wₛ^{o})=ASF_{C}(W) the following expression is valid:

∀i∈[1,n] ASF_{C}(Wₛⁱ)⊂ASF_{C}(Wₛⁱ⁻¹) (2)

Using the workflow instance acceptability condition, (2) is equivalent to:

∀i∈[1,n] ASF_{C}(Wₛⁱ)⊂ASF_{C}(Wₛⁱ⁻¹)⊂ASF_{C}(W) (3)

From those two aspects that yield the expression (3), a set Minₛₘ(sₐ,tₐ,Wₛⁱ) is computed that defines the minimum set of security mechanisms that should be supported by a component service sₐ in order to be assigned to a task tₐ at a step i of the assignment procedure. Computation of the set Minₛₘ(sₐ,tₐ,Wₛⁱ) is derived from the above cited expression (3). A component web service is to be assigned to a task tₐ at the step i such that at least one element part of ASF_{C}(Wₛⁱ⁻¹) is satisfied by the new generated partial workflow instance Wₛⁱ so that the following proposition holds.

$$\begin{matrix}{∃}_{ϒ} ∈ [ 1 , l ] such that \{ \begin{matrix}{sf}_{ϒ} ( W ) ∈ A S {F}_{C} ( {W}_{s}^{i - 1} ) \\ {sf}_{ϒ}^{a} ( W ) ⊆ S M S ( {s}_{a} )\end{matrix} & ( 4 ) \\ {Min}_{sm} ( {s}_{a} , {t}_{a} , {W}_{s}^{i} ) = \{ {sf}_{ϒ}^{a} ( W ) \vert {sf}_{ϒ} ( W ) ∈ A S {F}_{C} ( {W}_{s}^{i - 1} ) ] & ( 5 )\end{matrix}$$

In this case, a service s is an adequate candidate service to be assigned to task tₐ at step i of the assignment procedure if:

∃T ∈ Minₛₘ(sₐ, tₐ, Wₛⁱ) such that T⊂SMS(s)

As already mentioned above component web services which are available as candidate web services for composition of a composite web service, are assigned to each task of a workflow representing the composite web service to be generated, based on an iterative process. Depending on the single task requirements and the security mechanisms supported by the available web services which can be chosen for each task, different scenarios can occur when trying to assign task tₐ at step i:

(i) It exists a service s such that

∀ T ∈Minₛₘ(sₐ, tₐ, Wₛⁱ), T∈SMS(s).

In this case, s supports all the security mechanisms defined within Minₛₘ(sₐ, tₐ, Wₛⁱ) to be assigned to tₐ.

(ii) A single service is available for the task.

(iii) A set of services (sₖ)_{k ∈[1,p}_{ᵢ}_{]} is available that verifies:

∀k ∈[1,pᵢ] ∃Γₖ ∈ Minₛₘ(sₐ, tₐ, Wₛⁱ) such that ∀T ∈ Γₖ, T ⊂SMS(sₖ)

In this case, a subset of the services available for the task supports adequate security mechanisms to be assigned to tₐ but none satisfy them all.

With view to the different scenarios, an idea is therefore to assign first web services to the tasks verifying (i) and (ii) since there is no flexibility in the choice of the web service. Tasks verifying (iii) for which it is not possible to make any decision are finally analyzed. Based on the security requirements raised by the remaining tasks, first, services are assigned to tasks for which there is no more flexibility as a result of previous assignments and this process is then iterated till it is no longer possible to assign any web service. At this point, only tasks remain that verify (iii) but for which no decision can be made. This particular iteration in the assignment procedure for which it is no longer possible to make direct assignment is denoted in the following as iₛ. The goal here is to reach a solution to the problem if one exists that is find an element sf_{C}(W) satisfied by at least one of the component web services available for each task that are still to be assigned. Thus, an acceptable set of security features sf(W) is to be determined such that:

for each n−iₛ+1 task tₖ that are still to be assigned:

∃sₖ available for tₖ such that sf^{k}(W)⊂SMS(sₖ) (6)

Determining the previously formulated expression it can be achieved with an iterative procedure that takes as input the group ASF_{C}(Wₛⁱ⁻¹) and determines the set of elements that satisfy (6). The assignment procedure reaches a solution if the set of those elements is not empty. In this case, there might be several web services available for the same task and the choice can be made based for instance on additional non-functional attributes including for instance trust.

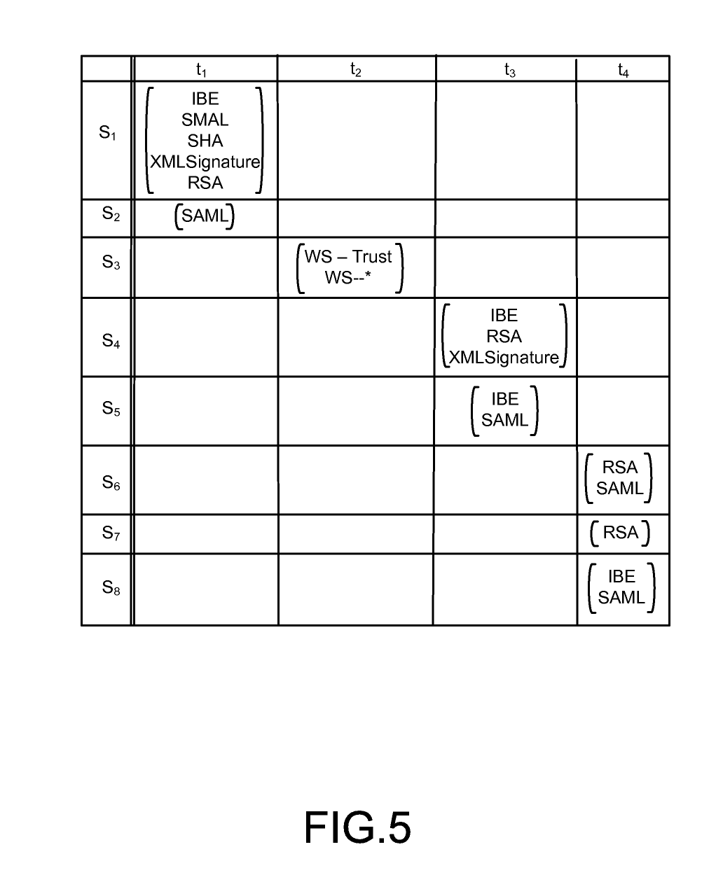

Considering the workflow example depicted in FIG. 4, the following example can be described. The table ASF_{C}(W₁) as depicted in FIG. 3 is defined as acceptable sets of security features for the considered workflow W₁. The set of component web services which are available for each task of the workflow W₁ is depicted in FIG. 5.

An embodiment of the proposed assigning procedure starts by assigning services to tasks for which there is no flexibility.

This is the case for task t₁ for which service s₁ matches all security requirements associated with the task t₁. Indeed, it is true that sf₁¹(W₁) ∪ sf₂¹(W₁) ∪ sf₃¹(W₁) ⊂ SMS(s₁), because sf₁¹(W₁)={IBE,SAML}, sf₂¹(W₁)={IBE,SHA}, sf₃¹(W₁)={IBE,XMLSignature} and SMS(s₁)={IBE,SAML,SHA,XMLSignature,RSA}. Thus s₁ can be assigned to t₁ and it holds that ASF_{C}(Wₛ¹)=ASF_{C}(W₁).

This is also the case for task t₂ for which a single service is available. Here it is true that sf₁²(W₁)={WS−*}, sf₂²(W₁)={WS−Trust}, sf₃²(W₁)={WS−*} and SMS(s₃)={WS−Trust, WS−*}. Thus, it is true that sf₁²(W₁) ∪ sf₂²(W₁) ∪ sf₃²(W₁) ⊂ SMS(s₃) thus ASF_{C}(Wₛ²)=ASF_{C}(W₁) as s₃ matches all security requirements.

With respect to task t₃ both available services, namely s₄, and s₅, match the security requirements since it is true that sf₁³(W₁)={IBE, RSA}, sf₂³(W₁)={IBE,SAML}, sf₃³(W₁)={IBE, WS−Trust}, and SMS(s₄)={IBE, RSA, XMLSignature}, and SMS(s₅)={IBE,SAML}. Before choosing one of the two available component web services task t₄ is to be considered. There are three different services s₆, s₇, and s₈ which can be chosen in order to fulfill task t₄. With respect to task t₄ it holds that sf₁⁴(W₁)={RSA}, sf₂⁴(W₁)={RSA, SAML}, sf₃⁴(W₁)={IBE, SAML} and thus sf₁⁴(W₁) ∪ sf₂⁴(W₁) ⊂ SMS(s₆), sf₁⁴(W₁) ⊂SMS(s₇) and sf₃⁴(W₁) ⊂ SMS(s₈).

No more web service can be directly assigned to any task and, therefore, iₛ as defined above, is to be denoted as iₛ=3 and ASF_{C}=(Wₛⁱ^{ₛ} ¹)=ASF_{C}(W₁). It can be shown that the minimal set of acceptable sets of security features that can be reached given the component web services available for tasks t₃ and t₄ is given by {sf₁(W₁),sf₂(W₁)}. Therefore, the following alternative for an assignment of remaining tasks is possible:

If s₄ is assigned to t₃, either s₆ or s₇ can be assigned to task t₄. The set of security features which is then satisfied would be sf₁(W).

On the other hand if s₅ is assigned to t₃, s₆ should be assigned to task t₄. The set of security features satisfied would be in this case sf₂(W).

A final decision can be made as already mentioned above, based on other non-functional attributes such as trust.

What is claimed is:

1. A computer-implemented method for automating an integration of security features as part of a composition procedure of web services, the method comprising:
providing a model which allows to define acceptable sets of security features ((sfₖ(W))_{k ∈ [1,1]}) associated with a particular workflow model (W) representing a composite web service (C), and to enable to advertise security features (SMS(sᵢ)) which are supported by available candidate web services (sᵢ); and
defining, generating and performing, based on the model, an assignment procedure which allows to build, based on the available candidate web services, a secure compliant composite web service which satisfies at least one of the acceptable sets of security features ((sfⱼ(W))_{j ∈[1,1]}) of the workflow model,
wherein the assignment procedure is an iterative process in that web services are assigned to workflow tasks one after the other such that after each iteration (i) a partial workflow instance (W_{S}ⁱ) is created, the partial workflow instance (W_{S}ⁱ) offering security mechanisms which are supported by the web services already assigned and which match at least one of the acceptable sets of security features for the respective iteration (i), and the at least one of the acceptable sets of security features is analyzed in view of a next succeeding workflow task of the workflow model so as to be successively completed to the at least one acceptable set of security features by compliant candidate web services.

2. The method as in claim 1 wherein acceptable sets of security features ((sfⱼ(W))_{j ∈ [1,1]}) associated with a particular workflow model (W) representing a composite web service (C) are matched against the advertised security features (SMS(sᵢ)) which are supported by available candidate web services (sᵢ).

3. The method as in claim 1 wherein given the particular workflow W comprising n tasks (tᵢ)_{i ∈[1,n]}, the assignment procedure outputs a compliant composite web service Wₛ=(sᵢ)_{i ∈[1,n]} composed of a set of n component services sᵢ that have been assigned to the tasks (tᵢ)_{i ∈[1,n]} of the particular workflow W.

4. The method as in claim 1 wherein the acceptable sets of security features ((sfⱼ(W))_{j ∈ [1,1]} associated with a particular workflow model (W) representing a composite web service (C), and the advertised security features (SMS(sᵢ)) which are supported by available candidate web services (sᵢ) are described using Web Service Definition Language (WSDL).

5. The method as in claim 1 wherein, for the particular workflow W, an operator security features is provided that associates with each task of the workflow W a set of security mechanisms ((sf^{k}(W))_{k ∈ [1,n]}).

6. The method as in claim 5 wherein the sets of security mechanisms, each being associated with a respective task, and the acceptable sets of security features ((sfⱼ(W))_{j ∈ [1,1]}) associated with the workflow W are represented in form of a matrix or table, thus indicating existing overlapping between the sets of security mechanisms, each being associated with a respective task, and the acceptable sets of security features ((sfⱼ(W))_{j ∈ [1,1]}) associated with the workflow W.

7. The method as in claim 5 wherein the secure compliant composite web service (Wₛ(sᵢ)_{i ∈ [1,n]}) satisfies the following proposition:
∃η ∈ [1, 1] such that ∀i ∈ [1, n] sfₙⁱ(W) ⊂ SMS(sᵢ)
wherein SMS(sᵢ) corresponds to a set of security mechanisms of a respective component web service sᵢ.

8. The method as in claim 1 wherein after each iteration (i) a partial workflow instance (Wₛⁱ) is created and a group of sets of security features (ASF_{C}(Wₛⁱ)=(sfₕ(Wₛⁱ))_{h ∈ [1,m]}) associated with the partial workflow instance (Wₛⁱ) and whose elements are satisfied by the partial workflow instance (Wₛⁱ) are determined, the group of sets of security features associated with the partial workflow instance (Wₛⁱ) being a subset of the group of sets of security features (ASF_{C}(W)=(sf,(W))_{j ∈ [1,1]}) associated with the particular workflow (W), and, based on the group of sets of security features (ASF_{C}(Wₛⁱ)=(sfₕ(Wₛⁱ))_{h ∈ [1,m]}) associated with the partial workflow instance (Wₛⁱ), security requirements that are to be satisfied by candidate component services in order to be assigned to subsequent workflow tasks of the particular workflow are computed.

9. The method as in claim 8 wherein the candidate component services are computed by using the following conditions:
∀i ∈ [1, n] ASF_{C}(Wₛⁱ) ⊂ ASF_{C}(Wₛ^{i 1}) ⊂ ASF_{C}(W)
wherein ASF_{C}(Wₛ⁰)=ASF_{C}(W) and ASF_{C}(Wₛⁱ) is the group of sets of security features associated with the partial workflow instance Wₛⁱ and ASF_{C}(W) is the group of acceptable sets of security features associated with the particular workflow W.

10. The method as in claim 9 wherein a service sₐ is classified as an adequate candidate component service to be assigned to task tₐ of the assignment procedure if:
∃T ∈ Minₛₘ(sₐ, tₐ, Wₛ)={sf_{γ}^{a}(W)|sf_{γ}(W) ∈ ASF_{C}(Wₛⁱ⁻¹)}
such that T ⊂ SMS (sₐ) wherein SMS (sₐ) are the advertised security features of service sₐ.

11. A system comprising:
a modeling unit that is configured to provide a model which allows to define acceptable sets of security features ((sfₖ(W))_{k ∈ [1,1]}) associated with a particular workflow model (W) representing a composite web service (C), and to enable to advertise security features (SMS(sᵢ)) which are supported by available candidate web services (sᵢ); and
an assignment unit that is configured to define, generate, and perform, based on the model, an assignment procedure which allows to build, based on the available candidate web services, a secure compliant composite web service which satisfies at least one of the acceptable sets of security features ((sfⱼ(W))_{j ∈[1,1]}) of the workflow model,
wherein the assignment procedure is an iterative process in that web services are assigned to workflow tasks one after the other such that after each iteration (i) a partial workflow instance (W_{S}ⁱ) is created, the partial workflow instance (W_{S}ⁱ) offering security mechanisms which are supported by the web services already assigned and which match at least one of the acceptable sets of security features for the respective iteration (i), and the at least one of the acceptable sets of security features is analyzed in view of the next succeeding workflow task of the workflow model so as to be successively completed to the at least one acceptable set of security features by compliant candidate web services.

12. The system of claim 11 wherein the assignment unit is configured to match acceptable sets of security features ((sfⱼ(W))_{j ∈ [1,1]}) associated with the particular workflow model (W) representing the composite web service (C) against the advertised security features (SMS(sᵢ)) which are supported by available candidate web services (sᵢ).

13. The system of claim 11 wherein given the particular workflow W consisting of n tasks (t)_{i ∈[1,n]}, the assignment unit is configured to output a compliant composite web service Wₛ=(sᵢ)_{i ∈[1,n]} composed of a set of n component services sᵢ that have been assigned to the tasks (tᵢ)_{i∈[1,n]} of the particular workflow W.

14. The system of claim 11 wherein the acceptable sets of security features ((sfⱼ(W))_{j ∈ [1,1]}) associated with a particular workflow model (W) representing a composite web service (C), and the advertised security features (SMS(sᵢ)) which are supported by available candidate web services (sᵢ) are described using Web Service Definition Language (WSDL).

15. The system of claim 11 wherein the modeling unit is configured to provide, for the particular workflow W an operator security features that associates with each task of the workflow W, a set of security mechanisms ((sf^{k}(W))_{k ∈ [1,n]}).

16. The system of claim 15 wherein the modeling unit is configured to represent the set of security mechanisms, each being associated with a respective task and the acceptable sets of security features associated with the workflow W in form of a matrix or table, thus indicating existing overlapping between the sets of security mechanisms, each being associated with a respective task, and the acceptable sets of security features ((sfⱼ(W))_{j ∈ [1,1]}) associated with the workflow W.

17. The system of claim 15 wherein the secure compliant composite web service (Wₛ(sᵢ)_{i ∈ [1,n]}) satisfies the following proposition:
∃η ∈ [1, 1] such that ∀i ∈ [1, n] sf_{η}ⁱ(W) ⊂ SMS(sᵢ)
wherein SMS(sᵢ) corresponds to a set of security mechanisms of a respective component web service sᵢ.

18. The system of claim 11 wherein the assignment unit is configured to create after each iteration (i) a partial workflow instance (Wₛⁱ) and to determine a group of sets of security features (ASF_{C}(Wₛⁱ)=(sfₕ(Wₛⁱ))_{h ∈ [1,m]}) associated with the partial workflow instance (Wₛⁱ) and whose elements are satisfied by the partial workflow instance (Wₛⁱ), the group of sets of security features associated with the partial workflow instance (Wₛⁱ) being a subset of the set of security features (ASF_{C}(W)=(sfⱼ(W))_{j ∈ [1,1]}) associated with the particular workflow (W), and to compute, based on the group of sets of security features (ASF_{C}(Wₛⁱ)=(sfₕ(Wₛⁱ))_{h ∈ [1,m]}) associated with the partial workflow instance (Wₛⁱ), security requirements that are to be satisfied by candidate component services in order to be assigned to subsequent workflow tasks of the particular workflow.

19. The system of claim 18 wherein the assignment unit computes the candidate component services by using the following conditions:
∀i ∈ [1, n] ASF_{C}(Wₛⁱ) ⊂ ASF_{C}(Wₛⁱ⁻¹) ⊂ ASF_{C}(W)
wherein ASF_{C}(Wₛ⁰)=ASF_{C}(W) and ASF_{C}(Wₛⁱ) is the group of sets of security features associated with the partial workflow instance Wₛⁱ and ASF_{C}(W) is the group of sets of security features associated with the particular workflow W.

20. The system of claim 19 wherein the assignment unit classifies a service sₐ as an adequate candidate component service to be assigned to task tₐ of the assignment procedure if:
∃T ∈ Minₛₘ(sₐ, tₐ, Wₛ)={sf_{y}^{a}(W)|sf_{y}(W) ∈ ASF_{C}(Wₛⁱ⁻¹)}
such that T ∈ SMS (sₐ) wherein SMS (sₐ) are the advertised security features of service sₐ.

21. A computer program product tangibly embodied on a computer-readable medium having executable instructions that, when executed, cause a data processing apparatus to:
provide a model which allows to define acceptable sets of security features ((sfₖ(W))_{k ∈ [1,1]}) associated with a particular workflow model (W) representing a composite web service (C), and to enable to advertise security features (SMS(sᵢ)) which are supported by available candidate web services (sᵢ); and
define, generate and perform, based on the model, an assignment procedure which allows to build, based on the available candidate web services, a secure compliant composite web service which satisfies at least one of the acceptable sets of security features ((sfⱼ(W))_{j ∈[1,1]}) of the workflow model,
wherein the assignment procedure is an iterative process in that web services are assigned to workflow tasks one after the other such that after each iteration (i) a partial workflow instance (W_{S}ⁱ) is created, the partial workflow instance (W_{S}ⁱ) offering security mechanisms which are supported by the web services already assigned and which match at least one of the acceptable sets of security features for the respective iteration (i), and the at least one of the acceptable sets of security features is analyzed in view of the next succeeding workflow task of the workflow model so as to be successively completed to the at least one acceptable set of security features by compliant candidate web services.
